(19) United States
(12) Patent Application Publication
(10) Pub. No.: US 2021/0404536 A1
(43) Pub. Date: Dec. 30, 2021

(54) POWER-SHIFT MULTI-SPEED TRANSMISSION

(71) Applicant: Robert Bosch GmbH, Stuttgart (DE)

(72) Inventors: Tobias Schlittenbauer, Asperg (DE); Ianislav Krastev, Ludwigsburg (DE); Wael Mohamed, Hemmingen (DE)

(21) Appl. No.: 17/288,705

(22) PCT Filed: Oct. 16, 2019
(86) PCT No.: PCT/EP2019/078074

§ 371 Date: Apr. 26, 2021

(30) Foreign Application Priority Data
Oct. 24, 2018 (DE) 10 2018 218 183.7

(51) Int. Cl. F16H 3/66; F16H 61/00; B60K 1/00; B60K 17/08; F16H 37/04

(52) U.S. Cl. CPC F16H 3/663; F16H 61/0059; B60K 1/00; B60K 17/08; F16H 2702/02; F16H 2200/0034; F16H 2200/2007; F16H 2200/2035; B60K 2001/001; F16H 37/042

(57) ABSTRACT

The invention relates to a multi-speed transmission (10) which is driven via an electric machine (64). The multi-speed transmission (10) has a planet carrier (22), on which at least one first and second stepped planetary gear (24, 30) are received. First planetary steps (26, 32) of the stepped planetary gears (24, 30) mesh with a first sun gear (18), and second planetary steps (28, 34) of the stepped planetary gears (24, 30) mesh with a second sun gear (20, 54). A first brake (38) is paired with the first sun gear (18), and a second brake (42) is paired with the second sun gear (20, 54), the actuation of each said brake producing a first gear ratio, a second gear ratio for a parking lock function, and an overlapping gear shift.

### BACKGROUND OF THE INVENTION

The invention relates to a power-shift multi-speed transmission, in particular a two-speed stepped planetary transmission which is used within the scope of an electric axle module for equipping electric vehicles. Furthermore, the invention relates to the use of the power-switch multi-speed transmission within an electric axle module.

DE 10 2016 011 263 A1 relates to a drive train device with an electric motor. The transmission assigned to the electric motor comprises at least one first planetary gear stage and one second planetary gear stage, which planetary gear stages have overall at most four toothing planes and three brake units. These are provided at least structurally for shifting at least three forward transmission gears which can be at least partially shifted in sequence.

DE 10 2015 218 252 A1 relates to a two-speed transmission for a vehicle, a drive train for the vehicle and to a gear shifting method. A two-speed transmission for a vehicle is proposed, having a sun gear at the input, wherein the sun gear at the input is connected to an input shaft, furthermore having a sun gear arranged on the output side, wherein said sun gear is connected to an output shaft. The output-side sun gear has a different diameter than the sun gear arranged on the input side. A planet carrier having a plurality of stepped planetary gears is provided, wherein the stepped planetary gears are mounted rotatably on the planet carrier, and wherein the stepped planetary gears each have a first and a second gear section. These are arranged coaxially with respect to one another and are connected to one another for conjoint rotation. The first gear sections mesh with the sun gear arranged on the input side while second gear sections mesh with the sun gear arranged on the output side. Furthermore, a first and a second controllable coupling device are provided in order to shift the two-speed transmission between the input shaft and the output shaft in two different transmission ratios.

DE 10 2013 201 711 B4 relates to a drive train. The drive train of the vehicle comprises at least one internal combustion engine, an electric machine and a transmission unit. The transmission unit is created as a planetary transmission. The planetary transmission contains a first sun gear which is connected to a first input shaft; furthermore, a second sun gear which is connected to a second input shaft. The planetary transmission furthermore comprises at least one first and at least one second planetary gear, and a planetary gear carrier which is assigned to the output shaft. The first planetary gear meshes with the first sun gear and the second planetary gear meshes with the second sun gear. The two planetary gears are coupled to each other effectively in terms of drive. A drive-effective coupling is produced by means of a stepped planetary gear.

### SUMMARY OF THE INVENTION

According to the invention, a power-shift multi-speed transmission is proposed which is driven via an electric machine and which has a planet carrier, on which at least one first and one second stepped planetary gear are held, wherein first planetary stages of the stepped planetary gears mesh with a first sun gear, and second planetary stages of the stepped planetary gears mesh with a second sun gear. The first sun gear is assigned a first brake, and the second sun gear is assigned a second brake, the actuation of which brakes can produce a first gear stage, a second gear stage of a parking lock function, and an overlapping gear shift.

By contrast with input transmissions that are generally installed on electric vehicles, the power-shift multi-speed transmission proposed according to the invention permits a first gear stage and a second gear stage such that a smaller electric machine can be used to cover the spectrum of drive requirements, said smaller electric machine also being able to be operated more frequently at higher or optimal efficiency.

Following the solution proposed according to the invention, the first brake interacts with a first housing-mounted brake disk, and the second brake with a second housing-mounted brake disk.

In an alternative embodiment possibility of the multi-speed transmission proposed according to the invention, the first sun gear is connected via an intermediate shaft to an inner brake disk which interacts with the housing-mounted second brake which is installed in an inner position. In this further embodiment, use is made of a modified second sun gear which comprises an outer brake disk which interacts with the housing-mounted first brake which is installed in an outer position.

The multi-speed transmission proposed according to the invention can be used in a first gear stage, in a second gear stage of a parking lock function, and within the scope of an overlapping gear shift.

A stationary transmission ratio i₀₁ of the multi-speed transmission is defined by the relationship

$${i}_{01} = \frac{{Z}_{ring gear}}{{Z}_{1. sR}}$$

where
Z_{ring gear}≙number of teeth of ring gear
Z_{LSR}≙number of teeth of the 1^{st} sun gear.

The first gear stage of the multi-speed transmission is defined by the transmission ratio according to the following relation:

$${i}_{01} = 1 - \frac{1}{{i}_{01}}$$

where
i₀₁≙stationary transmission ratio of the multi-speed transmission.

In order to implement a second gear stage of the multi-speed transmission proposed according to the invention, a stationary transmission ratio i₀₂ of the multi-speed transmission is defined by:

$${i}_{02} = \frac{{Z}_{ring gear \cdot {Z}_{2. P}}}{{Z}_{2. SR \cdot {Z}_{1. P}}}$$

where
Z_{ring gear}=number of teeth of ring gear
Z_{1.P}=number of teeth of 1^{st} planetary stage
Z_{2.SR}=number of teeth of 2^{nd} sun gear
Z_{2.P}=number of teeth of 2nd planetary stage

In the second gear stage of the multi-speed transmission, the transmission ratio i₀₂ thereof is defined by the following relation:

i₂=1−1/i₀₂

where i₀₂≙stationary transmission ratio of the multi-speed transmission.

In order to implement the respective first gear stage or the second gear stage, at the multi-speed transmission, in the first gear stage, the first brake is closed while the second brake is open, and, within the scope of the second gear stage, the first brake is open while the second brake is closed.

By means of the multi-speed transmission proposed according to the invention, in addition to the first gear stage and the second gear stage, it is also possible to realize a parking lock function in which the first brake and the second brake are in each case closed. In this case, the multi-speed transmission proposed according to the invention is blocked so that the vehicle is prevented from rolling away.

By means of the multi-speed transmission proposed according to the invention, an overlapping gear shift can also be produced, wherein, with simultaneous opening of one brake and associated closing of the respective other brake, a power shift without interruption of the tractive force can be produced. In order to carry out a continuous recuperation, a power downshift may also be of interest, i.e. shifting down from the second gear stage into the first gear stage, which brings dynamic advantages, for example, during cornering. During the overlapping gear shifts, the two brakes to be opened or to be closed are actuated substantially simultaneously.

The multi-speed transmission proposed according to the invention can be installed in an axially parallel installation position, i.e. axially parallel to the front or rear axle of a vehicle, or else in an axially perpendicular installation position, thus making it possible to take different structural conditions with respect to the vehicle chassis into account. The multi-speed transmission proposed according to the invention is driven by a first spur gear stage in particular within the scope of an electric axle module.

The invention furthermore also relates to an electric axle module which comprises the multi-speed transmission proposed according to the invention. The electric axle module comprises the multi-speed transmission, wherein the latter uses a differential or a torque-vectoring unit to drive axle outputs of a front axle or of the rear axle of a vehicle having at least one electric machine.

Furthermore, the invention relates to the use of the multi-speed transmission in an electric vehicle (EV) having at least one electric machine, or a hybrid vehicle (HEV) or a plug-in-hybrid-electric vehicle (PHEV).

The solution proposed according to the invention enables electrically driven vehicles to be provided with a multi-speed transmission permitting two gear stages, instead of with a previously installed input transmission arrangement. This permits the use of a smaller electric machine for covering the spectrum of drive requirements, with the electric machine being able to be operated at greater efficiency in particular because of two gear stages being able to be produced. Either the electric machine can be of smaller dimensions, or greater efficiency can be realized with a greater range, or smaller, more favorable and especially lighter batteries can be used in electric vehicles.

The multi-speed transmission proposed according to the invention makes it possible to use two brakes as shift elements, said brakes permitting a relatively simple actuation in comparison to clutches in spur gear transmissions.

Owing to the power shift capability, without an interruption of tractive force, of the multi-speed transmission proposed according to the invention, there are no interruptions to the force transmission during acceleration phases or during recuperation phases; furthermore, the requirement of synchronization can be dispensed with. In addition, the multi-speed transmission proposed according to the invention makes it advantageously possible to realize a parking lock function by complete blocking of the transmission, in particular by simultaneous closing of the two shift elements designed as brakes. As a result, a parking lock mechanism which is complex to integrate and the associated actuators can be dispensed with.

In the solution proposed according to the invention, only brakes serve as shift elements. Brakes are substantially less complex components in comparison to clutches. The assignment of the respective brakes to the sun gears leads to very low braking forces, and therefore the brakes which are used can be of smaller dimensions. Furthermore, a transmission which is of very compact design and can easily be integrated can be obtained by the solution proposed according to the invention.

### BRIEF DESCRIPTION OF THE DRAWINGS

The invention will be explained in more detail below with reference to the drawings, in which:

FIG. 1 shows a general design of the multi-speed transmission proposed according to the invention,

FIG. 2 shows an embodiment variant of the multi-speed transmission proposed according to the invention according to FIG. 1 with an improved integration option of brakes serving as shift elements,

FIG. 3 shows the design of the multi-speed transmission proposed according to the invention, and

FIG. 4 shows the multi-speed transmission proposed according to the invention integrated in an electric axle module which comprises a differential.

### DETAILED DESCRIPTION

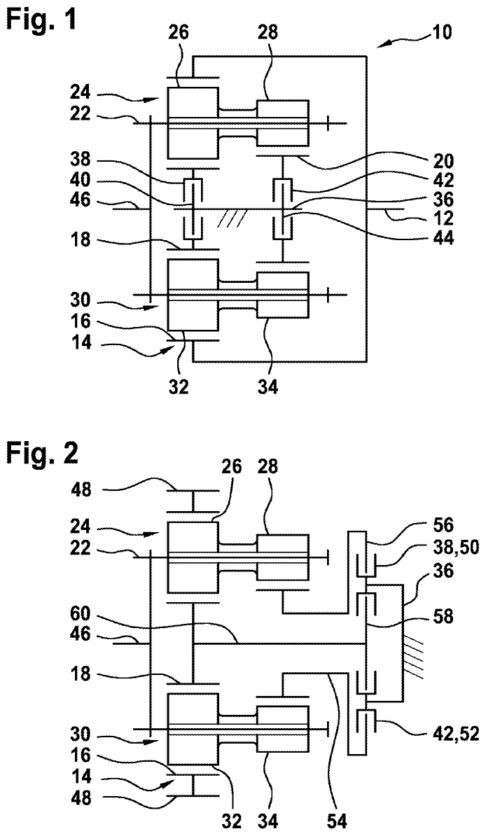

An embodiment variant of the multi-speed transmission 10 proposed according to the invention can be gathered from the illustration according to FIG. 1.

The multi-speed transmission 10 proposed according to the invention comprises a drive shaft 12 via which the drive of the multi-speed transmission 10 takes place by an electric machine. Furthermore, the multi-speed transmission 10 comprises a ring gear 14 which, in the embodiment variant illustrated in FIG. 1, has an internal toothing 16. The multi-speed transmission 10 furthermore comprises a first sun gear 18 and a second sun gear 20. The two sun gears 18 and 20 according to the first embodiment variant of the multi-speed transmission 10 illustrated in FIG. 1 differ in respect of their diameters. The multi-speed transmission 10 furthermore comprises a planet carrier 22.

At least 2 stepped planetary gears 24 and 30 are held in the planet carrier 22. A first stepped planetary gear 24 comprises a first planetary stage 26 and a second planetary stage 28 arranged coaxially with respect to the first stepped gear 24. Analogously, the second stepped planetary gear 30 comprises a first planetary stage 32 and a second planetary stage 34 which is likewise formed coaxially with respect to the first planetary stage 32 of the second stepped planetary gear 30.

A first housing-mounted brake disk 40 and a second housing-mounted brake disk 44 are located on a housing 36 of the multi-speed transmission 10. The first housing-mounted brake disk 40 interacts with a first brake 38 for the first sun gear 18, while a second brake 42 which interacts with the second housing-mounted brake disk 44 is assigned to the second sun gear 20 of the multi-speed transmission 10. An output shaft 46 transmits the torque fed into the multi-speed transmission 10 via the drive shaft 12 to the drive train of a vehicle having at least one electric machine 64.

It is revealed in the illustration according to FIG. 1 that the respective first planetary stages 26 and 32 of the first stepped planetary gear 24 and of the second stepped planetary gear 30 mesh with the internal toothing 16 of the ring gear 14. Also, the first planetary stages 26 and 32 of the two stepped planetary gears 24, 30 can mesh with the first sun gear 18, while the two second planetary stages 28 and 34 can mesh with the external toothing of the second sun gear 20. Owing to the arrangement of the first brake 38 and of the second brake 42, which brakes acts as a shift element, the first sun gear 18 can be blocked when the first brake is actuated; when the second brake 42 is actuated, the second sun gear 20 can be blocked.

In accordance with the brakes 38 and 42 serving as a shift element, a first gear stage, a second gear stage of a parking lock function, and an overlapping gear shift can be realized via the multi-speed transmission 10 illustrated in FIG. 1, as will also be explained below.

FIG. 2 shows a further embodiment variant of the multi-speed transmission 10 proposed according to the invention.

It is seen from the illustration according to FIG. 2 that the ring gear 14 has an external toothing 48 on its outer circumference in addition to its internal toothing 16. In contrast to the first embodiment variant of the multi-speed transmission 10 proposed according to the invention that is illustrated in FIG. 1, a modified second sun gear 54 is used thereon.

While, in the exemplary embodiment of the multi-speed transmission 10 proposed according to the invention that is illustrated in FIG. 1, the first brake 38 and the second brake 42 are integrated in the two sun gears 18 and 20, in the embodiment variant of the multi-speed transmission 10 illustrated in FIG. 2 the first brake 38 and the second brake 42 are no longer situated in the diameter of the first sun gear 18 and of the second modified sun gear 54, but rather are arranged laterally. This means that the diameters of the first sun gear 18 and of the modified second sun gear 54 can be of smaller dimensions because of the alternative arrangement of the first brake 38 and the second brake 42 laterally on the multi-speed transmission 10, which has a favorable effect on the overall size of the embodiment variant of the multi-speed transmission 10 according to the illustration in FIG. 2. In addition, the accessibility of the first brake 38 and of the second brake 42 for maintenance purposes is improved in comparison to the embodiment variant of the multi-speed transmission 10 according to FIG. 1 because of the lateral arrangement of the first brake 38 in an outer position 50 and the lateral arrangement of the second brake 42 in an inner position 52.

In the embodiment variant of the multi-speed transmission 10 according to FIG. 2, the modified second sun gear 54 comprises an outer brake disk 56. The latter interacts with the first brake 38. The first brake 38 is fixedly arranged on the housing 36, as is the second brake 42 which is arranged in an inner position 52. The modified second sun gear 54 is produced in such a manner that the outer brake disk 56 is formed thereon, while an inner brake disk 58 is coupled to the first sun gear 18 via an intermediate shaft 60.

The design of the multi-speed transmission 10 according to the illustration in FIG. 2 enables easier accessibility of the two brakes arranged laterally on the multi-speed transmission 10, i.e. of the first brake 38 in the outer position 50 and of the second brake 42 in the inner position 52.

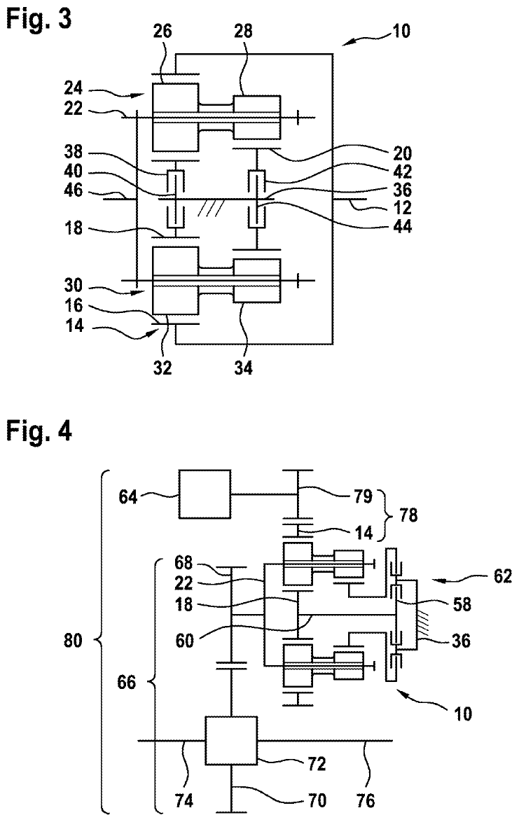

The functioning of the multi-speed transmission 10 proposed according to the invention will be explained in more detail below with reference to FIG. 3:

If the multi-speed transmission 10 is operated in the function of the first gear stage, the first brake 38 is closed while the second brake 42 is open. The ring gear 14 is driven via the drive shaft 12. The first sun gear 18 is supported against the housing 36 by the first brake 38 which is in the closed position. In this case, the planet carrier 22 with the at least two stepped planetary gears 24 and 30 forms the output, i.e. the planet carrier 22 drives the output shaft 46. In the function of the first gear stage, the first planetary stages 26, 32 of the at least two stepped planetary gears 24, 30 in each case mesh with the external toothing of the first sun gear 18.

A stationary transmission ratio i₀₁ of the multi-speed transmission 10 is defined by the quotient from the number of teeth of the ring gear 14 and of the first sun gear 18. The stationary transmission ratio i₀₁ is produced in accordance with the following relation:

$${i}_{01} = \frac{{Z}_{ring gear}}{{Z}_{1. SR}}$$

where
Z_{ring gear}≙number of teeth of ring gear 14
Z_{LSR}≙number of teeth of the 1^{st} sun gear 18

Accordingly, a transmission ratio i₁ is produced within the scope of the function of the first gear stage of the multi-speed transmission 10 proposed according to the invention in accordance with:

$${i}_{1} = 1 - \frac{1}{{i}_{01}}$$

where
i₀₁=stationary transmission ratio of the multi-speed transmission 10

If the multi-speed transmission 10 is operated in the function of the second gear stage, the first brake 38 is open while the second brake 42 is closed. Also in this case, the ring gear 14 is driven via the drive shaft 12 of the multi-speed transmission 10. The second sun gear 20 and the second modified sun gear 54 are supported against the housing 36 of the multi-speed transmission 10 by means of the second brake 42. In this case, the drive runs from the ring gear 14 to the two second planetary stages 28 and 34 of the at least one first stepped planetary gear 24 and of the at least one second stepped planetary gear 30. The output is transmitted to the planet carrier 22 and from the latter to the output shaft 46 of the multi-speed transmission 10 by means of the closed second brake 42.

In the function of the second gear stage of the multi-speed transmission 10 proposed according to the invention, a stationary transmission ratio i₀₂ of the multi-speed transmission is produced from the quotient of the number of teeth of the ring gear 14 z_{ring gear} (negative) and the number of teeth of the second sun gear 20 or of the modified second sun gear 54 according to the following relation:

$${i}_{02} = \frac{{Z}_{ring gear \cdot {Z}_{2. P}}}{{Z}_{2. SR \cdot {Z}_{1. P}}}$$

where
Z_{ring gear}≙number of teeth of ring gear 14
Z_{1.P}≙number of teeth of 1^{st} planetary stage
Z_{2.P}≙number of teeth of 2nd planetary stage
Z_{2.SR}≙number of teeth of the 2nd sun gear 20, 54.

The transmission ratio i₂ of the multi-speed transmission 10 during the function of the 2^{nd} gear stage is produced with regard to:

$${i}_{02} = 1 - \frac{1}{{i}_{02}}$$

where
i₀₂=stationary transmission ratio of the multi-speed transmission 10.

In addition to the two above-described functions of the first gear stage and second gear stage, the multi-speed transmission 10 proposed according to the invention can furthermore realize an overlapping gear shift while the power shift takes place without an interruption of the tractive force by simultaneous opening and closing of the first brake 38 and the second brake 42. The power shift without an interruption of tractive force is of interest in particular in acceleration phases of the vehicle having at least one electric machine 64. At the beginning of an overlapping gear shift, during the first gear stage the first brake 38 is closed while the second brake 42 is open. If an acceleration of the vehicle then takes place by means of the at least one electric machine 64, the first brake 38 initially remains closed, and the second brake 42 is open; during the shifting operation, the second brake 42 is now gradually closed and the first brake 38 gradually opened in order to produce the function of the second gear stage, i.e. changing of the gear stages.

The multi-speed transmission 10 proposed according to the invention furthermore permits the implementation of a parking lock function. This takes place in such a manner that the two brakes, i.e. the first brake 38 and the second brake 42, close simultaneously such that the multi-speed transmission 10 is locked and inhibited by two simultaneously engaged gear stages. The vehicle is not capable of starting to roll in this case.

A spread between the transmission ratios i₁, i₂ can be defined for a corresponding combination of number of teeth of ring gear 14 and the two first sun gears 18 and the second sun gears 20 and 54, in each case permitting the first and second gear stage.

FIG. 4 shows the multi-speed transmission 10 proposed according to the invention integrated in an electric axle module 80.

It can be seen from the illustration according to FIG. 4 that the power-shift multi-speed transmission 10 proposed according to the invention is arranged in an axially parallel installation position 62. Via a first spur gear stage 78, starting from the planetary carrier 22 via the output shaft 46, a pinion 68 of the first spur gear stage 78 is driven, with the first pinion 68 meshing with a second gear 70.

It is furthermore apparent from the illustration according to FIG. 4 that an electric axle module 80 comprises a differential 72 in addition to the multi-speed transmission 10 arranged in an axially parallel installation position 82. Instead of a differential 72, a torque-vectoring unit (TVE) can also be provided.

It is clear from FIG. 4 that the differential 72 has a first axle drive 74 and a second axle drive 76 via which drive wheels (not illustrated here) of a vehicle having at least one electric machine 64 are driven. FIG. 4 shows that, in this embodiment variant, the multi-speed transmission 10 is designed corresponding to the exemplary embodiment according to FIG. 2, i.e. the first brake 38 and the second brake 42 are located laterally on the multi-speed transmission 10, thus improving the accessibility of the two brakes 38 and 42. The multi-speed transmission 10, arranged in an axially parallel installation position 62, is driven by the electric machine 64 which, for its part, drives a pinion 79 which meshes with the external toothing 48 of the ring gear 14.

The simultaneous use of the ring gear 14 as a gearwheel of a first spur gear stage 78 permits an axially highly compact construction of the electric axle module 80. As an alternative to the axially parallel installation position 62, illustrated in FIG. 4, of the power-shift multi-speed transmission 10 proposed according to the invention, an axially perpendicular installation position 82 can also be undertaken, wherein the electric machine 64 in this case is in the form of a hollow shaft motor 84. The multi-speed transmission 10 according to the embodiment variants illustrated above can be installed on a front axle or a rear axle or on both axles of a vehicle having at least one electric machine 64. There is the possibility of combining the electric axle module 80 according to the schematic illustration in FIG. 4 with an electric input drive on the respective other vehicle axle, either a front axle or a rear axle, or else of providing a combination of internal combustion engines with manual transmissions.

The above invention is not restricted to the exemplary embodiments described here and to the aspects emphasized therein. On the contrary, a multiplicity of modifications lying within the scope of expert action are possible within the scope specified by the claims.

1. A multi-speed transmission (10) which is configured to be driven via an electric machine (64) and which has a planet carrier (22), on which at least one first stepped planetary gear (24) and one second stepped planetary gear (30) are held, and first planetary stages (26, 32) of the first and second stepped planetary gears (24, 30) mesh with a first sun gear (18), and second planetary stages (28, 34) of the first and second stepped planetary gears (24, 30) mesh with a second sun gear (20, 54), wherein the first sun gear (18) is associated with a first brake (38) and the second sun gear (20, 54) is associated with a second brake (42), and wherein the first and second brakes are configured such that the actuation of the first and second brakes can produce a first gear stage, a second gear stage, a parking lock function, and an overlapping gear shift.

2. The multi-speed transmission (10) as claimed in claim 1, characterized in that the first brake (38) interacts with a housing-mounted brake disk (40), and the second brake (42) interacts with a second housing-mounted brake disk (44).

3. The multi-speed transmission (10) as claimed in claim 1, characterized in that the first sun gear (18) is connected via an intermediate shaft (60) to an inner brake disk (58) which interacts with the second brake (42) which is housing-mounted and which is installed in an inner position (52).

4. The multi-speed transmission (10) as claimed in claim 1, characterized in that the second sun gear (54) comprises an outer brake disk (56) which interacts with the first brake (38) which is housing-mounted and which is installed in an outer position (50).

5. The multi-speed transmission (10) as claimed in claim 1, characterized in that a stationary transmission ratio i₀₁ of the multi-speed transmission (10) is defined by:
$${i}_{01} = \frac{{z}_{ring gear}}{{z}_{1. SR}}$$
where
Z_{ring gear}≙number of teeth of ring gear 14
Z_{2.SR}≙number of teeth of the 2^{nd} sun gear 20, 54
Z_{2P}≙number of teeth of 2^{nd} planetary stage
Z_{1P}≙number of teeth of 1^{st} planetary stage

6. The multi-speed transmission (10) as claimed in claim 5, characterized in that, in the first gear stage of the multi-speed transmission (10), the transmission ratio i₁ is defined by:
$${i}_{01} = 1 - \frac{1}{{i}_{01}}$$
where
i₀₁≙stationary transmission ratio of the multi-speed transmission (10)

7. The multi-speed transmission (10) as claimed in claim 1, characterized in that a stationary transmission ratio i₀₂ of the multi-speed transmission (10) is defined by:
$${i}_{02} = \frac{{Z}_{ring gear \cdot {Z}_{2. P}}}{{Z}_{2. SR \cdot {Z}_{1. P}}}$$
where
Z_{ring gear}≙number of teeth of ring gear (14)
Z_{2.SR}≙number of teeth of the 2^{nd} sun gear (20)

8. The multi-speed transmission (10) as claimed in claim 7, characterized in that, in the second gear stage of the multi-speed transmission (10), the transmission ratio i₂ is defined by:
$${i}_{02} = 1 - \frac{1}{{Z}_{02}}$$
where
i₀₂≙stationary transmission ratio of the multi-speed transmission (10).

9. The multi-speed transmission (10) as claimed in claim 1, characterized in that, in the first gear stage, the first brake (38) is closed and the second brake (42) is open, and, in the second gear stage, the first brake (38) is open and the second brake (42) is closed.

10. The multi-speed transmission (10) as claimed in claim 1, characterized in that, in the parking lock function, the first brake (38) and the second brake (42) are closed.

11. The multi-speed transmission (10) as claimed in claim 1, characterized in that, with simultaneous opening of one of the brakes (38, 42) and closing of the respective other brake (38, 42), during an overlapping gear shift a power shift takes place without an interruption of tractive force.

12. The multi-speed transmission (10) as claimed in claim 1, characterized in that said multi-speed transmission is integrated in an electric axle module (80) in an axially parallel installation position (62) or in an axially perpendicular installation position (82).

13. The multi-speed transmission (10) as claimed in claim 1, characterized in that the multi-speed transmission (10) is driven by a first spur gear stage (78) in the electric axle module (80).

14. An electric axle module (80) having a multi-speed transmission (10) as claimed in claim 1, characterized in that the latter uses a differential (72) or a torque-vectoring unit (86) to drive axle drives (74), (76) of a front axle or a rear axle of a vehicle having at least one electric machine (64).

15. (canceled)

16. A vehicle comprising the multi-speed transmission (10) as claimed in claim 1 and at least one electric machine (64).

17. The vehicle as claimed in claim 16, wherein the vehicle is an electric vehicle (EV).

18. The vehicle as claimed in claim 16, wherein the vehicle is a hybrid vehicle (HEV).

19. The vehicle as claimed in claim 16, wherein the vehicle is a plug-in-hybrid-electric vehicle (PHEV).
